(19) United States
(12) Patent Application Publication
(10) Pub. No.: US 2025/0343839 A1
(43) Pub. Date: Nov. 6, 2025

(54) SYSTEMS AND METHODS FOR PROVIDING CONTINUOUS SIGNATURE MANAGEMENT

(71) Applicant: Wells Fargo Bank, N.A., San Francisco, CA (US)

(72) Inventors: Kathryn Lynne Sanders, Charlotte, NC (US); Kelvin Hay, Hattiesburg, MS (US); Jaclyn Olmos-Lym, San Francisco, CA (US)

(21) Appl. No.: 18/656,035

(22) Filed: May 6, 2024

(51) Int. Cl. H04L 67/306; G06V 40/30; H04L 9/00

(52) U.S. Cl. CPC H04L 67/306; G06V 40/382; G06V 40/394

(57) ABSTRACT

Systems, apparatuses, methods, and computer program products are disclosed for providing continuous signature management. An example method includes detecting, by an event identification circuitry, a user authentication event and receiving, by communications hardware, a signature from the user during the user authentication event. The example method further includes determining, by the event identification circuitry, a signature parameter set for the signature and determining, by the event identification circuitry, whether the user authentication event corresponds to an authentic event type. The example method further includes in an instance in which the user authentication event corresponds to the authentic event type, storing, by signature management circuitry, the signature and corresponding signature parameter set in a signature profile associated with the user within a signature corpus.

### BACKGROUND

Signatures are often used across various industries, serving as a tool to signify an individual's agreement to particular terms and conditions and/or as an authentication factor to verify an individual's identity. However, the variability in an individual's signature due to a variety of different factors presents significant challenges in verifying a signature's legitimacy.

### BRIEF SUMMARY

As mentioned above, signatures are frequently used to serve as a unique identifier for an individual. Given that an individual's signature is wildly accepted to be unique to that individual, many entities across different industries utilize signatures as an authentication factor and/or to foster accountability by holding an individual responsible for their actions or decisions (e.g., signing a legal document, such as a contract). However, the quality of an individual's signature is often dependent upon a variety of variables (e.g., the type of writing utensil used, the media or apparatus used to capture the signature, the physical condition of the signee, the emotional state of the signee, a time constraint on the signee, environmental factors, the number of signatures produced by the signee during the user authentication event, and/or the like). As a result, signature verification methods are exposed to unique risks that do not exist for other authentication factors. In this regard, thoughtful signature verification techniques are required to ensure the authenticity of an individual's signature.

Entities that utilize an individual's signatures may implement signature verification techniques to investigate the authenticity of a signature, such as comparing an authentic signature (e.g., a signature that is known to be authentic) to an unknown signature (e.g., a signature that is not known to be authentic) to verify the authenticity of the unknown signature. For example, an entity may store an authentic signature associated with an individual as a reference signature, and upon receiving an unknown signature, the unknown signature may be compared to the reference signature. If the new signature and the reference signatures are similar (e.g., the unknown signature satisfies a similarity threshold), the new signature may be determined to be authentic. Conventionally, entities may only store one reference signature for the user, typically captured during an account opening period.

While evaluating the authenticity of an unknown signature with regard to a singular reference signature may detect nonauthentic signatures, utilizing a singular reference signature for analysis has many blind spots that may ultimately cause this signature verification technique to produce incorrect signature rejections/verifications. For example, an aged reference signature may not be capable of authenticating a newly received signature that is unknown to be authentic because the reliability of the aged reference signature has degraded over time. In particular, an aged reference signature may not adequately capture the breadth of variations to a signature that may occur over time, such as a change in handwriting style, a decline in fine-motor skills, or the like. Moreover, a singular reference signature may be incapable of capturing the multitude of different variables that may impact the quality of a signature (e.g., the writing utensil used, the physical condition of the signee, the emotional state of the signee, a time constraint on the signee, environmental factors, a time of day the signature was performed, the weather when the signee produced the signature, the frequency of signatures produced by the signee, and/or the like). For example, assume a reference signature is a handwritten signature that was produced with a pencil on a piece of paper. In this regard, a signature verification technique that solely uses the reference signature for comparison may struggle to produce an accurate signature verification result (e.g., determining whether a signature is authentic or nonauthentic) for a signature that was produced on a digital medium with a stylus. The inherent blind spots and limitations associated with utilizing a singular reference signature to verify an unknown signature presents a technical problem.

Example embodiments provide a technical solution to this technical problem by automatically monitoring for instances where a user is authenticated and capturing a signature from the user during this user authentication event. In doing so, a signature profile may be updated for the user such that a plurality of authentic signatures may be collected and stored for the user. In particular, example embodiments alleviate the issues discussed above by collecting authentic signatures, determining a signature parameter set for each collected signature, and storing the authentic signature and corresponding signature parameter set in a signature profile associated with the user within a signature corpus. To do so, example embodiments may detect a user authentication event. The user authentication event may refer to the occurrence of any real-world event that requires a user to verify their identity (e.g., via biometrics, a driver's license, via provision of credentials for a mobile application or web-based application and/or the like). Example embodiments may also receive a signature from the user during the user authentication event. The received signature may be an image of the signature, a copy of the signature, the actual signature, or the like. The user authentication event may be analyzed to determine whether the event corresponds to an authentic event type. In an instance in which the user authentication event corresponds to an authentic event type, the signature and signature parameter set captured during the user authentication event may be stored in a signature profile for the user. Otherwise, the signature and signature parameter set may be ignored and are not stored in the signature profile. By automatically detecting events in which the user is authenticated, embodiments described herein allows for signatures which are known to be authentic, to be captured for the user. Thus, a signature profile for the user may include a plurality of authentic signatures, thereby providing for a more robust and flexible signature profile for the user. Furthermore, the signature profile for the user may include only signatures known to be authentic by ignoring any signatures from a user captured during a user authentication event that does not correspond to an authentic event type. Thus, the integrity of the signature profile is maintained to include only authentic signatures from the user.

If a user authentication event corresponds to the authentic event type (e.g., an event in which the user has been successfully authenticated), example embodiments may store the signature and a corresponding signature parameter set in a signature profile associated with the user within a signature corpus. In some embodiments, the signature parameter corpus is a blockchain network and the signature profile is stored on the blockchain network. In response to determining the user authentication event corresponds to the authentic event type, example embodiments may generate a new block on the blockchain network that comprises the signature received during the user authentication event. Thus, the signatures stored for the user may be immutable and therefore, more secure and not accessible or modifiable to a would-be fraudster who may wish to alter the stored signatures. Alternatively, in some embodiments, the signature corpus may be a database, data repository, and/or the like.

Example embodiments may also determine a signature parameter set for the signature captured during the user authentication event. In some embodiments, a signature parameter may be a parameter, factor, value, etc. that is associated with the received signature. For example, a signature parameter may include a type of writing utensil used, the physical condition of the signee, the emotional state of the signee, a time constraint on the signee, environmental factors, a time of day the signature was performed, the weather when the signee produced the signature, the frequency of signatures produced by the signee, and/or the like. Thus, these signature parameters may influence the quality of the signature produced by the signee (e.g., the user).

Furthermore, the plurality of signatures included in the signature profile of the user may be used to provide enhanced signature verification for the user that may allow for more accurate and flexible signature verification of candidate signatures produced by the user. In particular, the signature profile for a user may include a plurality of authentic signatures from the user. Thus, the plurality of these signatures may be used to determine whether a candidate signature is authentic. In some embodiments, a trained machine learning model is leveraged to determine the authenticity of a candidate signature based on the signature profile. In particular, in some embodiments, machine learning techniques may be leveraged to infer an aggregated verification likelihood score for the candidate signature based on an inferred similarity between the candidate signature and one or more authentic signatures. In some embodiments, a signature verification likelihood score may be inferred for an authentic signature based on an inferred similarity between the particular authentic signature and the candidate signature. The aggregated verification likelihood score may then be inferred based on a signature verification likelihood score for each selected authentic signature. Thus, example embodiments provide a technical solution ensuring the efficient and objective determination of the authenticity of an unknown signature using the robust signature profile.

Additionally, example embodiments contemplated herein allow for a more computationally efficient and accurate signature verification result through consideration of signature parameter sets. In particular, in some embodiments, signatures included in the signature profile may be filtered based on an inferred similarity between the signature's signature parameter set and the signature parameter set associated with the candidate signature. Thus, this filtering process allows for consideration of authentic signatures obtained from the user under similar conditions or circumstances, which may affect the quality of the signature. Thus, example embodiments contemplated herein allow for selective consideration of authentic signatures from a signature profile, thereby resulting in a more computationally efficient and accurate signature verification result.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for providing continuous signature management, in accordance with some example embodiments described herein.

FIG. 4 illustrates an example flowchart for verifying a candidate signature, in accordance with some example embodiments described herein.

FIG. 5 illustrates an example flowchart for using an aggregated signature verification score to determine a signature verification result, in accordance with some example embodiments described herein.

FIG. 6 illustrates another example flowchart for causing performance of one or more operations associated with an action request type, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

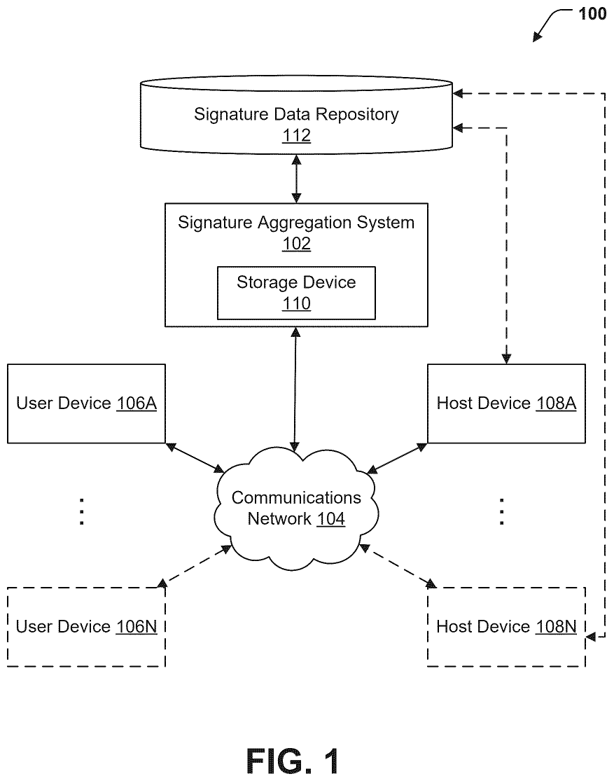

Example embodiments described herein may be implemented using any of a variety of computing devices or servers. To this end, FIG. 1 illustrates an example environment 100 within which various embodiments may operate. As illustrated, a signature aggregation system 102 may receive and/or transmit information via communications network 104 (e.g., the Internet) with any number of other devices, such as one or more of user devices 106A-106N and/or host devices 108A-108N.

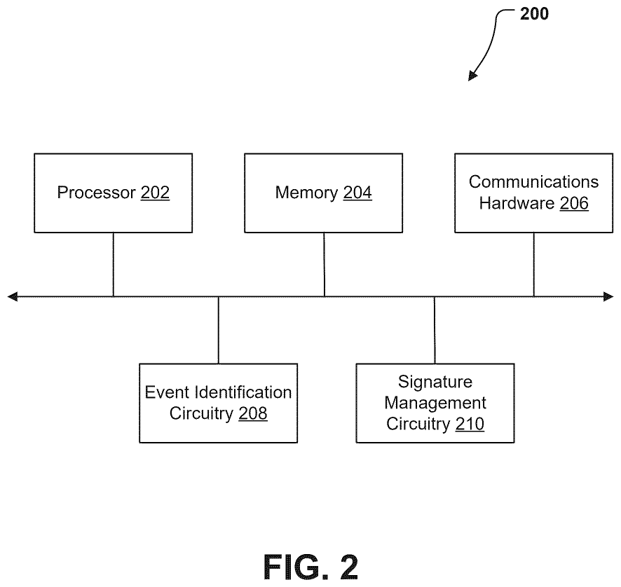

The signature aggregation system 102 may be implemented as one or more computing devices or servers, which may be composed of a series of components. Particular components of the signature aggregation system 102 are described in greater detail below with reference to apparatus 200 in connection with FIG. 2.

In some embodiments, the signature aggregation system 102 further includes a storage device 110 that comprises a distinct component from other components of the signature aggregation system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the signature aggregation system 102. Storage device 110 may store information relied upon during operation of the signature aggregation system 102, such as various algorithms that may be used by the signature aggregation system 102, data and documents to be analyzed using the signature aggregation system 102, or the like. In addition, storage device 110 may store control signals, device characteristics, and access credentials enabling interaction between the signature aggregation system 102, signature data repository 112, and one or more of the user devices 106A-106N or host devices 108A-108N.

The one or more user devices 106A-106N and the one or more host devices 108A-108N may be embodied by any computing devices known in the art. The one or more user devices 106A-106N and the one or more host devices 108A-108N need not themselves be independent devices, but may be peripheral devices communicatively coupled to other computing devices. In some embodiments, a user device (e.g., any one of user devices 106A-106N) may be associated with a user who has a signature profile stored on signature data repository 112. In some embodiments, a host device (e.g., any of the host devices 108A-108N) may be associated with the entity providing the signature management service provided by the signature aggregation system 102. In some embodiments, the entity managing signature aggregation system 102 and the entity with which the host devices (e.g., any one of host devices 108A-108N) are associated is the same entity.

In some embodiments, the signature data repository 112 may be a data repository (e.g., a database) that stores one or more signature profiles associated with one or more users. The signature data repository 112 may store data and documents (e.g., signatures and associated signature parameter sets) in a signature profile that were collected by signature aggregation system 102, and that may be subsequently used for analysis by the signature aggregation system 102. In some embodiments, the signature data repository 112 may be hosted on the cloud by a cloud service. In some embodiments, the signature data repository 112 may be embodied as one or more DAS devices (such as hard drives, solid-state drives, optical disc drives, or the like) or may alternatively comprise one or more NAS devices independently connected to a communications network (e.g., communications network 104).

In some embodiments, signature data repository 112 may be implemented as a distributed ledger technology (DLT) infrastructure, such as a blockchain. In some embodiments, signature data repository 112 may be embodied as a server or collection of servers that may interface with decentralized applications such as a distributed ledger to track or enable certain functionality. In some embodiments, the collection of networked distributed ledger nodes of a blockchain, which may be permissionless (public) or permissioned (private). For example, in some embodiments, signature data repository 112 may comprise a collection of networked distributed ledger nodes of a blockchain or blockchain technology that is capable of creating and exchanging blockchain tokens. In some embodiments, the distributed ledger may allow for Turing-complete scripting of contracts, known also as smart contracts, distributed applications, or decentralized applications, to be executed on the distributed ledger or blockchain. The distributed ledger may be related to other blockchain networks not pictured here. For example, the distributed ledger may be a sidechain of another blockchain network, or another network (not shown) may form a sidechain of the distributed ledger. The nodes may be embodied by specialized node devices, or may be embodied by any computing devices or server devices known in the art. In some embodiments, signature aggregation system 102 and/or any one or more of host devices 108A-108N may be a node of the distributed ledger or may be external to the blockchain. The signature data repository 112 may be accessible to the signature aggregation system and/or one or more host device 108A-108N. In some embodiments, a signature received during a user candidate authentication event that corresponds to an authentic event type may be stored within a block on the blockchain.

### Example Implementing Apparatuses

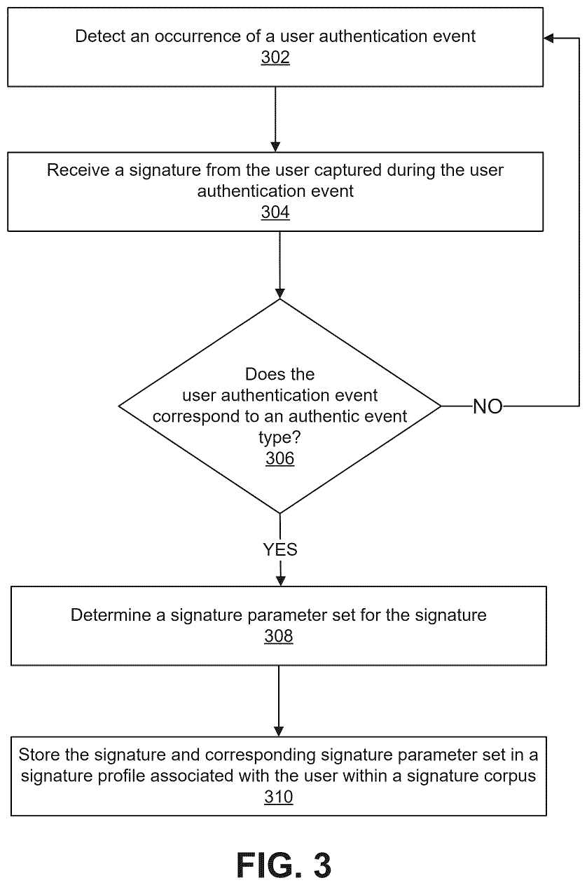

The signature aggregation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-6. As illustrated in FIG. 2, the apparatus 200 may include processor 202, memory 204, communications hardware 206, event identification circuitry 208, and signature management circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an event identification circuitry 208 that detects a user authentication event. In addition, the event identification circuitry 208 determines a signature parameter set for the signature and determines whether the user authentication event corresponds to an authentic event type. The event identification circuitry 208 may utilize processor 202, memory 204, or any other hardware component included in the apparatus 200 to perform these operations, as described in connection with FIG. 3 below. The event identification circuitry 208 may further utilize communications hardware 206 to gather data from a variety of sources (e.g., user device 106A through user device 106N, host device 108A through host device 108N, or storage device 110, as shown in FIG. 1), and/or exchange data with a user, and in some embodiments may utilize processor 202 and/or memory 204.

In addition, the apparatus 200 further comprises a signature management circuitry 210 that stores the signature and corresponding signature parameter set in a signature profile associated with the user within a signature corpus if the candidature user authentication event corresponds to the authentic event type. Further, signature management circuitry 210 may leverage a signature authentication model, that is utilized to determine the authenticity of a candidate signature. The signature management circuitry 210 may utilize processor 202, memory 204, or any other hardware component included in the apparatus 200 to perform these operations, as described in connection with FIGS. 3-6 below. The signature management circuitry 210 may further utilize communications hardware 206 to gather data from a variety of sources (e.g., user device 106A-106N or host devices 108A-108N, as shown in FIG. 1), and/or exchange data with a user, and in some embodiments may utilize processor 202 and/or memory 204.

Although components 202-210 are described in part using functional language, it will be understood that the particular implementations necessarily include the use of particular hardware. It should also be understood that certain of these components 202-210 may include similar or common hardware. For example, the event identification circuitry 208 and signature management circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the event identification circuitry 208 and signature management circuitry 210 may leverage processor 202, memory 204, or communications hardware 206 as described above, it will be understood that any of event identification circuitry 208 and signature management circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that event identification circuitry 208 and signature management circuitry 210 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by the signature aggregation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, event identification circuitry 208, signature management circuitry 210, and/or any combination thereof. It will be understood that user interaction with the signature aggregation system 102 may occur directly via communications hardware 206 or may instead be facilitated by a separate user device 106A-106N and/or a host devices 108A-108N, as shown in FIG. 1, and which may have similar or equivalent physical componentry facilitating such user interaction.

### Example Operations for Maintaining a Signature Profile

Turning first to FIG. 3, example operations are shown for providing continuous signature management to manage a signature profile for a user. Providing continuous signature management allows for the continuous updating of a user's signature profile over time (e.g., weekly, monthly, yearly, and/or the like) and/or may allow for updating a user's signature profile in response to a variety of triggers.

As shown by operation 302, the apparatus 200 includes means, such as processor 202, memory 204, event identification circuitry 208, or the like, for detecting occurrence of a user authentication event. In some embodiments, a user authentication event may be the occurrence of any real-world event that requires a user to be authenticated in any suitable manner (e.g., via biometrics, a driver's license, via provision of credentials for a mobile application or web-based application, and/or the like). In some embodiments, the occurrence of a user authentication event may involve a user, who may have an associated user account that is maintained and managed by apparatus 200. The user account may include relevant user information (e.g., a legal name, a residential address, a birthdate, email address, phone numbers, demographic information, account credentials, biometric data, and/or the like), account information (e.g., account identifiers, an account type, account parameters, and/or the like), user device information (e.g., user device identifiers, phone numbers, user device type, and/or the like), an indication of an associated signature profile, etc.

In some embodiments, the occurrence of a user authentication event may be the occurrence of an event that causes an authentication trigger. An authentication trigger may be an occurrence that triggers a requirement for authentication, which initiates a user authentication process. For example, an individual may enter a bank branch and request a bank teller to transfer funds from an account (e.g., a savings account) associated with the user to another account that may be associated with the user (e.g., a checking account). As a result, the apparatus 200 (e.g., communications hardware 206) may receive an electronic request from a computing device associated with the bank teller (e.g., any one of host devices 108A-108N) via a network (e.g., communications network 104, shown in FIG. 1), which describes the particular requested action (e.g., a transfer of funds). Upon receipt of this requested action, the communications hardware 206 may provide this information to event identification circuitry 208. The event identification circuitry 208 may then process the electronic request to determine an authentication trigger and in such an instance, the event identification circuitry 208 may initiate the user authentication event. Additionally, the electronic request may include information that identifies a user account corresponding to a particular user such that the event identification circuitry 208 may identify an associated user to which the electronic request pertains. For example, the user authentication event may include user information (e.g., a first and last name of the user, a birthdate, an email address, a residential address, credentials, biometric data, and/or the like) that the event identification circuitry 208 may use to identify the associated user account. In some embodiments, upon receiving an electronic request, communications hardware 206 may also store the electronic request in local storage device (e.g., memory 204, storage device 110, or the like).

In some embodiments, event identification circuitry 208 may detect a user authentication event based on the contents of an electronic request that requests the performance of an action that requires user authentication. For example, an electronic request may indicate an action request type, such as a withdrawal of funds, the opening a new account, the changing of a beneficiary on an account, updating account information, a transfer of funds, and/or the like, may be an authentication trigger that causes a user authentication event. A local storage device, such as memory 204, may include an authentication trigger list, which includes a list of all action request types that correspond to an authentication trigger. In some embodiments, the authentication trigger list includes action request types known to require authenticate of the user and also, involve a user signature. Thus, the event identification circuitry 208 may use this authentication trigger list to determine whether an action request type included in the electronic request corresponds to the authentication trigger list. In an instance in which the action request type corresponds to the authentication trigger list, the event identification circuitry 208 may detect a user authentication event. Alternatively, in an instance in which the action request type does not correspond to an action request type in the authentication trigger list (e.g., the action request type does not involve user authentication and/or does not require capture of a user signature), the event identification circuitry 208 may fail to detect a user authentication event. As such, upon receiving an electronic request, event identification circuitry 208 may process the received electronic request to identify the action request type and use the authentication trigger list to determine whether the identified action request type involves is included in the authentication trigger list.

As shown by operation 304, the apparatus 200 includes means, such as processor 202, memory 204, communications hardware 206, or the like, for receiving a signature from the user captured during the user authentication event. The received signature may be a handwritten signature from the user that was captured during the user authentication event. In some embodiments, the signature may be an image (e.g., a photo or scanned document) that includes a handwritten signature (e.g., a signature signed on a paper document). Alternatively, a signature may be a digital signature, such as a signature captured by a digital pen or stylus on a touch screen device that is connected to the apparatus 200 via a network (e.g., communications network 104, shown in FIG. 1).

In some embodiments, the signature may be received by the apparatus 200 (e.g., communications hardware 206) from a computing device associated with the user (e.g., user device 106A, user device 106N, or the like), a computing device associated with an entity (e.g., host device 108A, host device 108N, or the like) that is requiring a signature from the user, and/or the like, via communications network 104. In some embodiments, the electronic request may include the signature. For example, the apparatus 200 may receive an electronic request that requests the performance of an action request type to change a beneficiary of an account associated with the user. As such, the user may be required to complete a change of beneficiary form on a computing device (e.g., user device 106A, host device 108A, or the like), and to complete the change of beneficiary form, the user may be required to sign the form before transmitting the completed (e.g., signed) form to the apparatus 200 (e.g., communications hardware 206). Thus, the signature may be included in the electronic request.

Additionally, or alternatively, an automatic temporal trigger event may cause the apparatus 200 to transmit an electronic signature request to a computing device associated with the user during the user authentication event. The electronic signature request may be an electronic notification comprising instructions for a user to submit a signature to the apparatus 200 (e.g., communications hardware 206). An automatic temporal trigger event may describe rules and/or configurations that require the transmission of a signature request within a particular time period or at a particular point in time. For example, an automatic temporal trigger event may be automatically activated periodically (e.g., annually), such that the apparatus 200 collects a signature from the user at least once a year during a user authentication event. As a result, the apparatus 200 may automatically transmit an electronic signature request to a computing device associated with the user (e.g., user device 106A, or the like) in real-time upon detecting the user authentication event. Subsequently, the apparatus 200 (e.g., communications hardware 206) may receive a completed signature request, which comprises a signature from the user during the user authentication event.

As shown by operation 306, the apparatus 200 includes means, such as processor 202, memory 204, event identification circuitry 208, or the like, for determining whether the user authentication event corresponds to an authentic event type. An authentic event type may refer to a user authentication event where the user authentication process (e.g., biometrics, one-time password, driver's license verification, or the like) associated with the user authentication event produced a successful authentication result. For example, assume the authentication procedure triggered by the user authentication event required a user to transmit biometric data (e.g., a facial image, fingerprint, and/or the like) to the apparatus 200. As a result, if the transmitted biometric data successfully authenticates the user associated with the user authentication event, event identification circuitry 208 may determine that the user authentication event corresponds to an authentic event type. Upon determining that the user authentication event corresponds to an authentic event type, the procedure may advance to operation 310.

In contrast, event identification circuitry 208 may determine that the user authentication event does not correspond to an authentic event type, and instead corresponds to a nonauthentic event type. A nonauthentic event type may refer to a user authentication event where the user authentication procedure produced an unsuccessful authentication result. For example, assume the user authentication event triggered an authentication procedure that required the user to transmit their fingerprint to the apparatus 200 (e.g., communications hardware 206) for analysis. If the analysis did not yield a successful authentication result, event identification circuitry 208 may determine that the user authentication event corresponds to a nonauthentic event type. To this end, the apparatus 200 (e.g., communications hardware 206) may transmit a message via a network (e.g., communications network 104, shown in FIG. 1) to a computing device associated with the user (e.g., user device 106A, or the like) that requests the user to complete a different authentication procedure (e.g., utilizing a one-time-password), such that the user authentication event corresponds to an authentic event type upon successful completion of a different authentication procedure. In some embodiments, if the user authentication event corresponds to a nonauthentic event type, the apparatus 200 may not store the signature received from the user.

In some embodiments, the communications hardware 206 may receive an indication from a host device (e.g., any one of host devices 108A-108N) indicative of whether the user was authenticated. For example, a user may provide his/her driver's license to a bank teller and the bank teller may manually authenticate the user based on his/her provided driver's license. In such an instance, the communications hardware 206 may receive an indication of whether the bank teller successfully authenticated the user manually. In an instance the user was successfully manually authenticated, the event identification circuitry 208 may determine that the user authentication event corresponds to an authentic event type. In an instance the user failed to be manually authenticated, the event identification circuitry 208 may fail to determine that the user authentication event corresponds to an authentic event type.

Alternatively, in some embodiments, the event identification circuitry 208 may process content included in the electronic request and/or subsequent communications to determine whether the user authentication event is an authentic event type. For example, the event identification circuitry 208 may receive user data, such as user credentials, a passcode, an image of a driver's license, biometric data, etc. from the user. The event identification circuitry 208 may compare the received user data to user data stored in the user account and determine whether the received user data corresponds to the stored user data. For example, the event identification circuitry 208 may directly compare received user data, such as user credentials (e.g., a password and/or username) or a one-time passcode, to corresponding user data stored in the user account (e.g., a configured password and/or username, a provided one-time password, or the like). In an instance in which the received user data exactly matches the stored user data, the event identification circuitry 208 may determine the user authentication event corresponds to an authentic event type. Alternatively, in an instance in which the received user data does not exactly match the stored user data, the event identification circuitry 208 may fail to determine the user authentication event corresponds to an authentic event type. This could be a result that the user who provided the user data is not the user to whom the user account corresponds (e.g., a potentially fraudulent access attempt) or could be the result of an incorrect entry or provision of the user data by the user.

In some embodiments, the event identification circuitry 208 may leverage one or more machine learning models to perform the comparison. In particular, received user data, such as a driver's license image, biometric data, etc. from the user may require additional processing to determine whether the user authentication event corresponds to an authentication event type. In such embodiments, the event identification circuitry 208 may use one or more authentication machine learning models. These authentication machine learning models may be configured to identify a similarity score between the received user data and the stored user data. For example, an authentication machine learning model may be a neural network, such as a convolutional neural network (CNN) or the like, configured to compare key features between received user data and stored user data to infer a similarity score, indicative of the inferred similarity between the two. In an instance in which the similarity score satisfies a similarity score threshold, the event identification circuitry 208 may determine the user authentication event corresponds to an authentic event type. Alternatively, in an instance in which the similarity score fails to satisfy the similarity score threshold, the event identification circuitry 208 may fail to determine the user authentication event corresponds to an authentic event type.

As shown by operation 308, the apparatus 200 includes means, such as processor 202, memory 204, communications hardware 206, event identification circuitry 208, or the like, for determining a signature parameter set for the signature. The signature parameters set may comprise one or more parameters associated with the received signature that may influence the quality of the signature produced by the signee (e.g., a user). For example, the signature parameter set may include the type of writing utensil used, the physical condition of the signee, the emotional state of the signee, a time constraint on the signee, environmental factors, a time of day the signature was performed, the weather when the signee produced the signature, the media or apparatus used to capture the signature (e.g., paper, touch screen, signature pad, cursor, or the like), the number of signatures produced by the signee during the user authentication event, and/or the like. In some embodiments, one or more signature parameters may be received with the signature. For example, the signature received in operation 304 may include associated metadata, such as the time and day the signature was captured, the location where the signature was captured, the type of writing utensil used, the media or apparatus used, and/or the like. Thus, if the authentication event corresponds to an authentic event type, event identification circuitry 208 may automatically determine one or more signature parameters from the metadata associated with the received signature.

Additionally, or alternatively, the event identification circuitry 208 may use associated metadata or other content from the electronic request to determine one or more signature parameters. For example, the signature may include associated metadata indicative of a location where the signature was obtained. Upon determining a location and/or date and/or time of the signing, event identification circuitry 208 may utilize an application programable interface (API) to retrieve data, such that environmental factors, such as weather, may be included in the signature parameter set. For example, event identification circuitry 208 may construct a request that includes an API key associated with a weather API (e.g., OpenWeatherMap, Weatherstack, Dark Sky, or the like) that authenticates the apparatus 200 and grants the apparatus 200 access to weather data. In this regard, event identification circuitry 208 may construct a weather data API request that specifies particular parameters, such as the location of the computing device that transmitted the signature received during the user authentication event, the time the signature was received or the time an image of the signature was captured, and/or the like. Upon constructing the weather data API request, event identification circuitry 208 may leverage communications hardware 206 to transmit the request to the endpoint associated with the requested data. Subsequently, communications hardware 206 may receive the API response. Communications hardware 206 may store the API response in a local storage device (e.g., memory 204, storage device 110, or the like) and/or transmit the API response to event identification circuitry 208, such that event identification circuitry 208 may extract weather data indicative of a parameter to include in the signature parameter set, such as temperature, humidity, precipitation, and/or the like.

In some embodiments, the electronic request and/or additional communications received by the communications hardware may include media depicting the user. In some embodiments, the event identification circuitry 208 may be configured to process the media, such as by using any suitable image processing models, to determine one or more signature parameters. For example, the event identification circuitry 208 may use a machine learning model, such as a convolutional neural network, to process images or video of the user and infer an emotional state of the user based on the media. The inferred emotional state of the user may be a signature parameter. The event identification circuitry 208 may include each signature parameter in a defined signature parameter set. In some embodiments, each signature parameter may also be associated with a signature parameter type.

Finally, as shown by operation 310, the apparatus 200 includes means, such as processor 202, memory 204, communications hardware 206, signature management circuitry 210, or the like, for storing the signature and corresponding signature parameter set in a signature profile associated with the user within a signature corpus (e.g., signature data repository 112). The signature profile may be a data construct that includes the image of one or more signatures received from a user during user authentication events and a signature parameter set corresponding to the one or more signatures. In some embodiments, the signature corpus may be a database that includes the signature profile associated with the user. In this regard, the signature corpus may provide a centralized and organized repository for storing a signature profile associated with the user.

In some embodiments, upon determining that the user authentication event corresponds to an authentic event type and determining a signature parameter set for the signature, signature management circuitry 210 may add the signature and corresponding signature parameter set to an already existing signature profile stored within the signature corpus (e.g., signature data repository 112). Alternatively, if a signature profile is not already established for a particular user, signature management circuitry 210 may generate a signature profile that comprises the signature and corresponding signature parameter set and subsequently store the signature profile within the signature corpus. For example, signature management circuitry 210 may leverage communications hardware 206 to transmit the signature and corresponding signature parameter set to signature data repository 112, such that signature data repository 112 may generate a signature profile associated with the user that may store the signature and corresponding signature parameter set. In some embodiments, the signature profile may be linked to the user account for the user. Additionally, or alternatively, the signature profile may include user information such that the correct signature profile may be identified for the corresponding user.

In some embodiments, the signature corpus is a blockchain network. In this regard, the signature profile may be stored on a block included on the blockchain network. As such, if a signature is received as described in relation to operation 304 and the user authentication event is determined to be an authentic event type as described in relation to operation 308, a new block on the blockchain may be generated to memorialize the updated signature profile associated with the user. In this regard, signature management circuitry 210 may generate a new block on the blockchain network, such that the new block comprises the signature received during the user authentication event and the corresponding signature parameter set. For example, signature management circuitry 210 may leverage communications hardware 206 to broadcast the signature and corresponding signature parameters to a transaction pool, such that miners may ultimately generate a new block that includes the signature and corresponding signature parameters.

### Example Operations for Verifying a Candidate Signature Using the Signature Profile

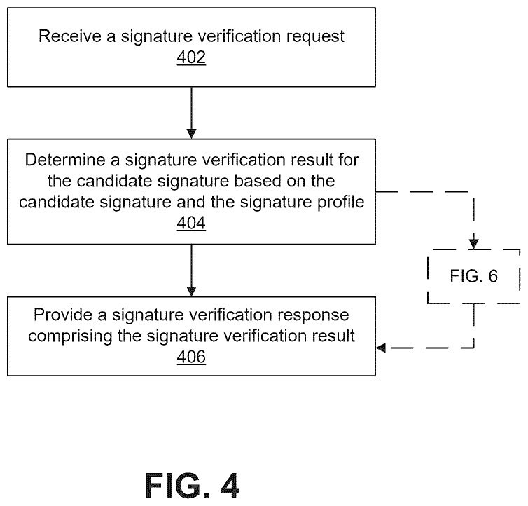

Turning now to FIG. 4, example operations are shown for utilizing the signature corpus to provide a signature verification response.

As shown by operation 402, the apparatus 200 includes means, such as processor 202, memory 204, communications hardware 206, or the like, for receiving a signature verification request. The signature verification request may be an electronic request that comprises a candidate signature from the user. The candidate signature may be handwritten signature (e.g., a signature produced by using a stylus, pen, pencil, or the like) that is received within a signature verification request. In some embodiments, the candidate signature may be an image (e.g., a photo or scanned document) that includes a handwritten signature (e.g., a signature signed on a paper document). Alternatively, the candidate signature may be a digital signature (e.g., a signature produced using a digital pen, stylus, finger, cursor, or the like) captured by a digital pen or stylus on a computing device that is connected to the apparatus 200 via a network (e.g., communications network 104, shown in FIG. 1). For example, a digital signature may be captured from a digital touchscreen on a computing device (e.g., host device 108A, or the like). Additionally, the signature verification request may indicate a user and/or user account with whom the candidate signature is associated. For example, the signature verification request may include user information (e.g., a first and last name of the user, a birthdate, an email address, a residential address, credentials, biometric data, and/or the like) that signature management circuitry 210 may use to identify the user account for the user to who allegedly produced the candidate signature.

In some embodiments, the signature verification request may be received by the apparatus 200 via a computing device associated with the user or a computing device associated with an entity that wants to verify the user's signature. For example, communications hardware 206 may receive the signature verification request from a computing device associated with the user (e.g., any one of user devices 106A-106N). Alternatively, if the user is within a bank branch or another entity that includes computing devices connected to the apparatus 200, communications hardware 206 may receive an image of the candidate signature via a signature verification request from a computing device associated with the bank branch or other entity (e.g., any one of host devices 108A-108N or the like). Upon receiving the signature verification request, communications hardware 206 may store the signature verification request within a local storage device (e.g., memory 204, storage device 110, or the like). Alternatively, communications hardware 206 may immediately transmit the signature verification request to the signature management circuitry 210 for subsequent analysis.

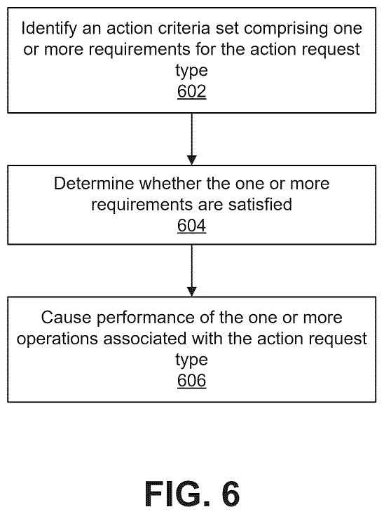

In some embodiments, the signature verification request may include an action request of an action request type. As described in more detail in FIG. 6, an action request type may be associated with an action criteria set that includes one or more requirements that must be met before associated operations may be performed. A local storage device, such as memory 204, may include an action trigger list, which includes a list of all action request types that are associated with an action criteria set and requires performance of one or more operations. In some embodiments, the action trigger list includes action request types known to require a verified user signature. In some embodiments, the action request types included in the action trigger list may differ from the action request types included in the authentication trigger list. Thus, the event identification circuitry 208 may use this action trigger list to determine whether an action request type included in the signature verification request corresponds to the action trigger list. In some embodiments, the action request types included in the action trigger list may be an indication of a real-world operation that is requested to be performed upon successful verification of the candidate signature. For example, the signature verification request may include a candidate signature from a user and may be indicative of an action request type, such as a request to open a new user account. Here, the new account opening action request type may require the candidate signature from the signature verification request be verified prior to opening the new user account.

As shown by operation 404, the apparatus 200 includes means, such as processor 202, memory 204, signature management circuitry 210, or the like, for determining a signature verification result for the candidate signature based on the candidate signature and the signature profile. The signature verification result may indicate whether the candidate signature is verified or non-verified. For example, a signature verification result may be categorical value of “verified” or “not verified”, a numerical value of 1 for a verified signature or 0 for non-verified signature, a Boolean value of “true” for a verified signature or “false” for a non-verified signature, etc. A verified signature may indicate that there is a sufficient likelihood that the candidate signature provided in the signature verification request was produced by the purported user. Alternatively, a non-verified signature may indicate that there was an insufficient likelihood that the candidate signature was produced by the purported user. This may be due to the candidate signature being produced by a fraudulent user attempting to replicate the user's signature or may be the result of a poor quality of the candidate signature, a lack of authentic signatures within the signature profile for the user, a true temporary or permanent change in the user's signature style (e.g., due to physical impairments that may affect the user's signature temporarily or permanently), or the like.

As described in FIG. 3, the signature profile for a user may include signatures produced by the user during a user authentication event known to be of an authentic event type. Thus, the signature profile for the user may include one or more authentic signatures for the user. The signature management circuitry 210 may use one or more of the signatures from the signature profile. In particular, the signature management circuitry 210 may identify the signature profile for the user that is stored within a signature corpus. In some embodiments, the signature management circuitry 210 may use the user information included in the signature verification request to identify a corresponding user account. In some embodiments, the user account may be linked to the signature profile for the user such that the signature management circuitry 210 may identify the signature profile for the user via the user account. Alternatively, in some embodiments, the signature management circuitry 210 may directly identify the signature profile for the user within the signature corpus using the user information provided in the signature verification request.

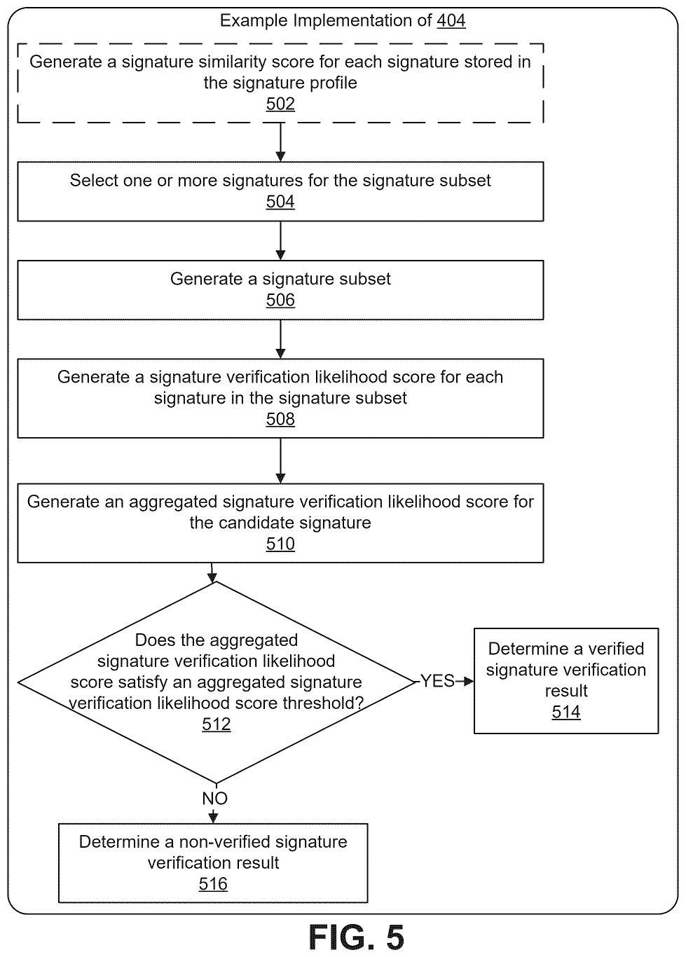

Once the signature management circuitry 210 has identified the signatures from the signature profile of the user indicated in the signature verification request, the signature management circuitry 210 may use these signatures to determine a signature verification result for the candidate signature. As described in further detail in FIG. 5, the signature management circuitry 210 may determine an aggregated signature verification likelihood score for the candidate signature and use this to determine the signature verification result.

In some embodiments, the performance of an action (e.g., an action requested with the candidate signature) may depend on the signature verification result. For example, a verified signature may enable or cause the performance of a particular requested action. However, a non-verified signature verification result may cause the performance of another action (e.g., initiating an authentication procedure to authenticate the user). In some embodiments, signature management circuitry 210 may use a signature authentication model to determine the signature verification result for the candidate signature based on the candidate signature and the signature profile.

In some embodiments, determining a signature verification result for the candidate signature using the signature profile may be performed in accordance with the operations described by FIG. 5. Turning now to FIG. 5, example operations are shown for using an aggregated signature verification likelihood score to determine a signature verification result.

Optionally, as shown by operation 502, the apparatus 200 includes means, such as processor 202, memory 204, signature management circuitry 210, or the like, for generating a signature similarity score for each signature stored in the signature profile. As described above, the signature profile may include one or more signatures produced by the user that were captured during a user authentic event determined to be an authentic event type. In some instances, signatures included in the signature profile may vary in relevancy as compared to the candidate signature. In particular, signatures that were produced under similar conditions as the candidate signature may be more relevant than other signatures. For example, if the candidate signature is a digital signature produced using a digital signature pad and a stylus, a signature produced under similar conditions may be more relevant than a signature produced under other conditions (e.g., via a cursor, touch screen, wet signature on paper, or the like). Thus, in some embodiments, the signature management circuitry 210 may be configured to generate a signature subset that includes a portion of the signatures from the signature profile.

To do so, in some embodiments, the signature management circuitry 210 may generate a signature similarity score for each signature stored in signature profile. The signature similarity score for a signature may be generated based on an inferred similarity between a corresponding signature parameter set for the signature and a signature parameter set for the candidate signature. In some embodiments, the signature management circuitry 210 may use a signature selection model to generate the signature similarity score for each stored signature. The signature selection model may calculate a signature similarity score (e.g., a numerical score) for each signature based on a comparison of the signature parameters in the signature parameter set for each signature and the signature parameters in the signature parameter set for the candidate signature. In some embodiments, the signature similarity score may be calculated based on the amount of similar signature parameters between the signature parameter set associated with a signature included in the signature profile and the signature parameter set associated with the candidate signature. For example, assume the signature parameter set associated with the candidate signature comprises ten different parameters. If the signature parameter set associated with the signature from the signature profile comprises six of the same parameters, the signature selection model may generate a signature similarity score of 0.6 indicating an inferred similarity of sixty percent. Alternatively, the signature similarity score may be based on weighted calculation where some parameters included in the signature parameter set are weighted higher than others. The weights may be predetermined and/or learned by the signature selection model.

In some embodiments, the signature selection model may be a machine learning or deep learning model. The signature selection model may be a CNN, a recurrent neural network (RNN), a decision tree, a random forest, and/or the like that is configured to receive signatures from the signature profile and associated signature parameters and the candidate signature and associated signature parameters and output a signature similarity score for each signature. In particular, the signature selection model may be configured to apply any suitable algorithms to determine the signature similarity score for a given signature. In particular, the signature selection model may apply a cosine similarity algorithm, a Jaccard similarity algorithm, a Euclidean distance algorithm, a Pearson correlation coefficient algorithm, a dynamic time warping algorithm, a Levenshtein distance algorithm, a Mahalanobis distance algorithm, and/or the like. The signature selection model may be configured to apply any one or more of these algorithms to one or more signature parameters in a signature parameter set for a signature against corresponding signature parameters in a signature parameter set for the candidate signature to determine the signature similarity score.

In some embodiments, the signature similarity score may be a numerical score (e.g., a score between 0 and 1 as mentioned in the above example), while in other embodiments the signature similarity score may be converted into a categorical result (e.g., tier 1/tier 2/tier 3, green/yellow/red, or some other categorical classification). For example, a comparison of the signature parameter sets corresponding to a signature included in the signature profile and the candidate signature may yield a high numerical score (e.g., 0.95) for a particular signature that has a similar signature parameter set to the signature parameter set associated with the candidate signature. Once the signature selection model has determined the signature similarity score for a signature, it may output the signature similarity score and an indication of the corresponding signature to the signature management circuitry 210.

As shown by operation 504, the apparatus 200 includes means, such as processor 202, memory 204, signature management circuitry 210, or the like, for selecting one or more signatures for the signature subset. The signature management circuitry 210 may select the signatures to include in the signature subset based on one or more rules and/or a signature similarity score determined for a given signature. In some embodiments, the signature management circuitry 210 may retrieve the signature parameter subset rules from a local storage device (e.g., memory 204), which may describe a similarity score threshold that each signature must satisfy to be included in the signature subset and/or other logical and/or mathematical operations that the signature management circuitry 210 need perform. The signature parameter subset rules may also require the signature management circuitry 210 to compare the signature similarity score for each signature stored in the signature profile to the corresponding similarity score threshold. In an instance in which the similarity score for a signature satisfies a corresponding similarity score threshold, the signature management circuitry 210 may select the signature for the signature subset. In an instance in which the similarity score for a signature fails to satisfy a corresponding similarity score threshold, the signature management circuitry 210 does not select the signature for the signature subset. As a result, signature management circuitry 210 may select any signature included in the signature profile that is associated with a similarity score that satisfies the similarity score threshold to be included in the signature subset.

In some embodiments, upon retrieval of the set of signature parameter subset rules, signature management circuitry 210 may utilize one or more filtering operations to select the one or more signatures. In some embodiments, the signature management circuitry 210 may be configured to apply one or more signature parameter subset rules to the signatures and/or associated signature parameters. For example, the signature parameter subset rules may require the signature management circuitry 210 to filter out or not include signatures captured prior to a particular date. This may allow for the exclusion of older signatures. Furthermore, the signature parameter subset rules may require the signature management circuitry 210 to apply one or more mathematical and/or logical operations to generate the signature subset. For example, the signature parameter subset rules may require that signature management circuitry 210 exclude signatures captured prior to a particular date if and only if the total count of signatures resulting selected signatures is greater than or equal a threshold count. As such, the signature parameter subset rules may allow for flexibility such that both signature relevancy and a number of signatures may both be considered to result in a more accurate signature verification result.

As shown by operation 506, the apparatus 200 includes means, such as processor 202, memory 204, signature management circuitry 210, or the like, for generating the signature subset. In particular, the signature management circuitry 210 may generate the signature subset to include the one or more selected signatures as determined in operation 504. Thus, the signature management circuitry 210 may generate a signature subset that includes relevant signatures from the signature profile, which may reduce the number of signatures analyzed, thereby allowing for a more computationally efficiency analysis while still maintaining an accurate signature verification result.

As shown by operation 508, the apparatus 200 includes means, such as processor 202, memory 204, signature management circuitry 210, or the like, for generating a signature verification likelihood score for each signature in the signature subset. The signature verification likelihood score for a particular signature may be generated based on a comparison between one or more particular features (e.g., stroke length, curvature, directionality, pressure sensitivity, and/or the like) of the signature and a corresponding one or more particular features associated with the candidate signature. In some embodiments, the signature verification likelihood score may be a numerical score, while in other embodiments the signature verification likelihood score may be converted into a categorical result. A signature verification likelihood score may be generated for each signature included in the signature subset.

In some embodiments, the signature management circuitry 210 may use a signature authentication model to generate the signature verification likelihood score for a signature based on one or more comparisons between one or more features associated with the candidate signature and one or more features associated with a signature from the signature subset. In some embodiments, the signature authentication model is a machine learning model configured to perform these comparisons between the candidate signature and a signature included in the signature subset to generate the signature verification likelihood score. In some embodiments, the signature authentication model is a CNN that may be trained to extract or otherwise determine one or more features from a signature where the one or more features correspond to a particular feature type (e.g., curvature, stroke patterns, directionality, pressure sensitivity, and/or the like). For example, the one or more signature authentication model may determine that the candidate signature has a stroke length of 10 pixels, a curvature of 25 degrees, and a directionality of 20 degrees. The signature authentication model may utilize any suitable image processing technique, such as noise reduction or the like, to enhance the image of the signature. In addition, the signature authentication model may also utilize a segmentation technique to isolate the signature for further analysis described below.

In some embodiments, the signature authentication model may be trained using a labeled signature dataset that comprises signatures with corresponding labels that indicate one or more parameters that may be included in the signature parameter set. For example, the labeled signature dataset may comprise labels that indicate a particular writing utensil that was used by the user to produce the signature, the time of day the signature was produced, the type of signing material, the writing angle of the user that produced the signature, the physical condition of the signee, environmental factors, and/or the like. As a result, during training, the signature authentication model may learn to extract or determine particular signature characteristics (e.g., a particular signature's stroke thickness, curvature, spacing, pressure sensitivity, the direction and angle of the strokes, and/or the like), which may be associated with a particular parameter included in the signature parameter set. For example, the signature authentication model may be utilized to determine a particular writing utensil that was used to generate the signature. As such, the signature authentication model may learn that stroke thickness and curvature are strong indicators of the particular type of writing utensil utilized to produce a signature, and thus update its weights accordingly.

The signature authentication model may use the one or more features associated with a given signature and the one or more features from the candidate signature and compare the one or more features of the same feature type. For example, assume the one or more features and corresponding feature types for the candidate signature and the signature included in the signature subset are (i) a stroke length of 10 pixels, curvature of 10 degrees, directionality of 20 degrees and (ii) a stroke length of 10 pixels, curvature of 15 degrees, directionality of 25 degrees. In this regard, the signature authentication model may generate a partial signature verification likelihood score based on a comparison between the same feature types. As such, in the above example the signature authentication model may generate three partial signature verification likelihood scores, such that the first partial signature verification likelihood score indicates a stroke length similarity, the second partial signature verification likelihood score indicates a curvature similarity, and the third partial signature verification likelihood score indicates a directionality similarity. In some embodiments, each partial signature verification likelihood score may be a numerical score (e.g., a score between 0 and 1), while in other embodiments the partial signature verification likelihood score may be converted into a categorical result (e.g., tier 1/tier 2/tier 3, green/yellow/red, or some other categorical classification).

In some embodiments, the partial signature verification likelihood score for each feature type may be combined to generate a signature verification likelihood score. The signature authentication model may use any suitable method (e.g., calculating an average, calculating a weighted average, or the like) to combine the partial signature verification scores to generate a signature verification likelihood score. For example, the signature authentication model may assign weights to each partial signature verification likelihood score based on the corresponding feature type associated with each partial signature verification score. For example, a local storage device, such as memory 204, may store a set of partial signature verification rules that describe particular weights associated with each feature type. As such, signature management circuitry 210 may provide the set of partial signature verification rules to the signature authentication model, such that the signature authentication model may weigh each generated partial signature verification score to generate the signature verification likelihood score associated with a particular signature included in the signature subset.

In some embodiments, the signature verification likelihood scores for each signature included in the signature subset may be stored in a local storage device (e.g., memory 204, storage device 110, or the like) and/or may be stored in the signature profile on the signature corpus (e.g., signature data repository 112) in association with its corresponding signature. As a result, signature management circuitry 210 may retrieve the signature verification likelihood scores for each signature included in the signature subset and provide the signature verification likelihood scores to the signature authentication model, such that the signature authentication model may generate an aggregated signature verification likelihood score for the candidate signature based on the signatures included in the signature subset. In some embodiments, the signature authentication model may use any suitable method to determine the aggregated signature verification likelihood score for the candidate signature. For example, the signature authentication model may calculate an average of the signature verification likelihood scores, calculate a summation of the signature verification likelihood scores, calculate a weighted average (e.g., weighting each signature differently based on the age of each signature included in the signature subset, or the like), or the like.

As shown by operation 510, the apparatus 200 includes means, such as processor 202, memory 204, signature management circuitry 210, or the like, for generating an aggregated signature verification likelihood score for the candidate signature based on the signature subset. The aggregated signature verification likelihood score may indicate a confidence that the candidate signature is authentic (e.g., a signature produced by the user). In some embodiments, the aggregated signature verification likelihood score may be a numerical score (e.g., a score between 0 and 1), while in other embodiments the aggregated signature verification likelihood score may be converted into a categorical result (e.g., tier 1/tier 2/tier3, green/yellow/red, or some other categorical classification). In some embodiments, the aggregated signature verification likelihood score may be based on a signature verification likelihood score generated for each signature in the signature subset.

In some embodiments, signature management circuitry 210 may use the signature authentication model to generate the aggregated signature verification likelihood score. The signature authentication model may generate an aggregated signature verification likelihood score for the candidate signature based on the signatures included in the signature subset. In some embodiments, the signature authentication model may use any suitable method to determine the aggregated signature verification likelihood score for the candidate signature. For example, the signature authentication model may calculate an average of the signature verification likelihood scores, calculate a summation of the signature verification likelihood scores, calculate a weighted average (e.g., weighting each signature differently based on the age of each signature included in the signature subset, or the like), or the like. Once the signature authentication model has generated the aggregated signature verification likelihood score, it may output it to the signature management circuitry 210.

As shown by operation 512, the apparatus 200 includes means, such as processor 202, memory 204, signature management circuitry 210, or the like, for determining whether the aggregated signature verification likelihood score for the candidate signature satisfies an aggregated signature verification likelihood score threshold. The aggregated signature verification likelihood threshold may be a predetermined score threshold set by an entity that is providing the signature aggregation system 102. In some embodiments, the aggregated signature verification likelihood score threshold may be stored in a local storage device (e.g., memory 204, or the like). In this regard, signature management circuitry 210 may retrieve the signature verification likelihood score threshold and compare the aggregated signature verification likelihood score to the signature verification likelihood score threshold to determine whether the aggregated signature verification likelihood score satisfies the signature verification likelihood score threshold.

In some embodiments, the aggregated signature verification likelihood score threshold may be dynamic and change depending on the content of the signature verification request. For example, the aggregated signature verification likelihood score threshold may change based on a particular action (e.g., an action request type) that may be requested to be performed by the apparatus 200. Thus, the signature management circuitry 210 may be required to identify the aggregated signature verification likelihood score threshold for the particular action request type indicated by the signature verification request. As described above, in some embodiments, the signature verification request may include a requested action of an action request type. Each action request type may be associated with an action criteria set and associated operations. The action criteria set may describe a set of conditions (e.g., one or more requirements). In some embodiments, the action criteria set may describe a signature verification likelihood threshold value that a candidate signature's aggregated signature verification likelihood score must satisfy to cause complete the associated action of the action request type (e.g., opening a new user account).

In some embodiments, the action criteria set may be stored in a local storage device (e.g., memory 204, storage device 110, or the like). In some embodiments, the action criteria set may store the one or more requirements associated with a particular action request type in the form of key-value pairs, where the key corresponds to the action request type and the value corresponds to the one or more requirements associated with the action request type. As a result, signature management circuitry 210 may search the action criteria set for the action request type included in the signature verification request to identify requirements for an aggregated signature verification likelihood score threshold associated with the action request type. If no aggregated signature verification likelihood score threshold is defined in the action criteria set for the action request type, the signature management circuitry 210 may be configured to select and use a default aggregated signature verification likelihood score threshold.

In an instance in which the aggregated signature verification likelihood score satisfies the aggregated signature verification likelihood score threshold, the process may proceed to operation 514. As shown by operation 514, the apparatus 200 includes means, such as processor 202, memory 204, signature management circuitry 210, or the like, for determining a verified signature verification result. In this instance, the aggregated signature verification likelihood score determined for the candidate signature was sufficiently similar to the signatures stored in the signature profile such that it satisfied the aggregated signature verification likelihood score threshold. Thus, the signature management circuitry 210 may determine a verified signature verification result for the candidate signature.

In an instance in which the aggregated signature verification likelihood score fails to satisfy the aggregated signature verification likelihood score threshold, the process may proceed to operation 516. As shown by operation 516, the apparatus 200 includes means, such as processor 202, memory 204, signature management circuitry 210, or the like, for determining a non-verified signature verification result. In this instance, the aggregated signature verification likelihood score determined for the candidate signature was not sufficiently similar to the signatures stored in the signature profile such that it failed to satisfy the aggregated signature verification likelihood score threshold. Thus, the signature management circuitry 210 may determine a non-verified signature verification result for the candidate signature.

Returning to FIG. 4, as shown by operation 406, the apparatus 200 includes means, such as processor 202, memory 204, communications hardware 206, or the like, for providing a signature verification response comprising the signature verification result. The signature verification response may be an electronic notification and/or message that comprises an indication (e.g., a message, a symbol, or the like) that the candidate signature was either verified or non-verified. In particular, the signature verification response may include the signature verification result. In this regard, communications hardware 206 may provide the signature verification response to a computing device associated with the user (e.g., any one of user devices 106A-106N) or an entity (e.g., any one of host devices 108A-108N, or the like) by transmitting the signature verification response via a network (e.g., communications network 104, shown in FIG. 1) to the computing device associated with the user or the entity that transmitted the signature verification request. As such, the user or entity that provided the signature verification request may be provided with an indication of whether the user's signature was verified.

Turning next to FIG. 6, example operations are shown for performing one or more operations associated with an action request type.

As shown by operation 602, the apparatus 200 includes means, such as processor 202, memory 204, signature management circuitry 210, or the like, for identifying an action criteria set comprising one or more requirements for the action request type. As described above, in some embodiments, the signature verification request may include a requested action of an action request type. Each action request type may be associated with an action criteria set and associated operations. The action criteria set may describe a set of conditions (e.g., one or more requirements) that must be satisfied in order to cause performance of a particular action type. In addition or in lieu of a defined aggregated signature verification likelihood score threshold, the action criteria set may additionally or alternatively describe other requirements for the action request type. For example, the action criteria set may define requirements that require that particular parameters that must be included in the signature parameter set associated with the candidate signature, a required number of signatures from the user, manual signoffs from certain users or entities, a total number of electronic or physical forms to be submitted and/or analyzed, etc. While the operation described in FIG. 4 may be used to verify an individual signature, the operations described in FIG. 6 allow for automated operations to be performed, which may have different and/or more strict requirements to allow for performance of these operations.

In some embodiments, the action criteria set may be stored in a local storage device (e.g., memory 204, storage device 110, or the like). In some embodiments, the action criteria set may store the one or more requirements associated with a particular action request type in the form of key-value pairs, where the key corresponds to the action request type and the value corresponds to the one or more requirements associated with the action request type. As a result, signature management circuitry 210 may search the action criteria set for the action request type included in the signature verification request to identify the one or more requirements associated with the action request type.

As shown by operation 604, the apparatus 200 includes means, such as processor 202, memory 204, signature management circuitry 210, or the like, for determining whether the one or more requirements are satisfied. In some embodiments, signature management circuitry may retrieve the signature profile from the signature corpus (e.g., signature data repository 112) or a local storage device (e.g., memory 204, storage device 110, or the like) to determine whether the one or more requirements are satisfied. For example, if the one or more requirements specify that the candidate signature must be a wet signature in blue ink, signature management circuitry 210 may search the signature parameter set for a parameter indicating the color and type of signature associated with the candidate signature to determine whether the one or more requirements are satisfied.

In some embodiments, if the one or more requirements fail to be satisfied, signature management circuitry 210 may cause performance of one or more supplemental operations associated with the action request type. The one or more supplemental operations may be one or more real-world operations that may be required to be performed by the apparatus 200 to satisfy the one or more requirements. In some embodiments, the one or more supplemental operations may be included in the action criteria set in association with the one or more requirements. For example, if a particular requirement fails to be satisfied, a particular supplemental action may be performed to remedy the failed requirement. In this regard, the successful completion of one or more supplemental operations associated with the failed requirement or plurality of failed requirements may cause performance of the one or more operations associated with the action request type. For example, assume one or more requirements associated with the action request type fail to be satisfied. Signature management circuitry 210 may identify in the action criteria set, using any suitable technique, one or more supplemental operations associated with the request type, such as leveraging communications hardware 206 to transmit a one-time password to a computing device associated with the user, causing a multifactor authentication process, requesting a new candidate signature, and/or the like.

Finally, as shown by operation 606, the apparatus 200 includes means, such as processor 202, memory 204, communications hardware 206, signature management circuitry 210, or the like, for causing performance of the one or more operations associated with the action request type. In some embodiments, signature management circuitry 210 may retrieve from a local storage device (e.g., memory 204, storage device 110, or the like) instructions for causing performance of the one or more operations associated with the action request type. To this end, signature management circuitry 210 may cause performance of the one or more operations. For example, the one or more operations associated with the action request type are associated with establishing a secured session with a computing device associated with the user. As such, signature management circuitry 210 may leverage communications hardware 206 to establish a secure session with a computing device associated with the user (e.g., user device 106A, user device 106N, or the like). As another example, the one or more operations associated with an action request type for opening a new user account may initiate a new user account opening process and perform preliminary steps (e.g., populating known user information) until manual intervention is needed (e.g., additional information from the user and/or entity).

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable an improved ability to verify the legitimacy of signatures. Example embodiments thus provide tools that overcome the problems faced by traditional signature verification techniques that rely on a few or a singular reference signature and do not account for the various factors that may impact the quality of a signature. By automatically collecting signatures that are received from a user while the user is authenticated, example embodiments generate a signature profile comprising a diverse collection of signatures that may ultimately be used for authentication that has historically not been available. Moreover, embodiments described herein avoid problems faced with aged data by automatically collecting a signature from a user based on a trigger event.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing continuous signature management, the method comprising:
detecting, by an event identification circuitry, an occurrence of a user authentication event associated with a user;
receiving, by communications hardware, a signature from the user captured during the user authentication event;
determining, by the event identification circuitry, whether the user authentication event corresponds to an authentic event type; and
in an instance in which the user authentication event corresponds to an authentic event type:
determining, by the event identification circuitry, a signature parameter set for the signature, and
storing, by signature management circuitry, the signature and corresponding signature parameter set in a signature profile associated with the user within a signature corpus.

2. The method of claim 1, further comprising:
receiving, by the communications hardware, a signature verification request, wherein the signature verification request comprises a candidate signature from the user;
determining, by the signature management circuitry and using a signature authentication model, a signature verification result for the candidate signature based on the candidate signature and the signature profile, wherein the signature verification result is indicative of whether the candidate signature is verified or non-verified; and
providing, by the communications hardware, a signature verification response comprising the signature verification result.

3. The method of claim 2, further comprising:
generating, by the signature management circuitry and using the signature authentication model, a signature subset comprising one or more signatures from the signature profile;
generating, by the signature management circuitry and using the signature authentication model, an aggregated signature verification likelihood score for the candidate signature based on the signature subset; and
determining, by the signature management circuitry, whether the aggregated signature verification likelihood score for the candidate signature satisfies an aggregated signature verification likelihood score threshold, wherein (a) the signature verification result is indicative that the candidate signature is verified in an instance in which the aggregated signature verification likelihood score for the candidate signature satisfies the aggregated signature verification likelihood score threshold and (b) the signature verification result is indicative that the candidate signature is non-verified in an instance in which the aggregated signature verification likelihood score for the candidate signature fails to satisfy the aggregated signature verification likelihood score threshold.

4. The method of claim 3, further comprising, for each signature in the signature subset, generating, by the signature management circuitry and using the signature authentication model, a signature verification likelihood score for the candidate signature, wherein the aggregated signature verification likelihood score is generated based on the signature verification likelihood score.

5. The method of claim 3, further comprising:
generating, by the signature management circuitry, a signature similarity score for each signature stored in the signature profile, wherein the signature similarity score for a signature is based on an inferred similarity between a corresponding signature parameter set for the signature and a signature parameter set for the candidate signature; and
selecting, by the signature management circuitry, one or more signatures for the signature subset based on an associated signature similarity score.

6. The method of claim 2, wherein the signature verification request further comprises an action request type, wherein the method further comprises:
identifying, by the signature management circuitry, an action criteria set comprising one or more requirements for the action request type;
determining, by the signature management circuitry and based on the candidate signature, whether the one or more requirements are satisfied; and
in an instance in which the one or more requirements are satisfied, causing, by the signature management circuitry, performance of one or more operations associated with the action request type.

7. The method of claim 6, further comprising in an instance in which one or more of the one or more requirements fail to be satisfied, causing, by the signature management circuitry, performance of one or more supplemental operations associated with the action request type.

8. The method of claim 1, wherein the signature corpus is a blockchain network and the signature profile is stored on the blockchain network.

9. The method of claim 8, further comprising in response to determining the user authentication event corresponds to the authentic event type, generating, by the signature management circuitry, a new block on the blockchain network, wherein the new block comprises the signature received during the user authentication event.

10. An apparatus for providing continuous signature management, the apparatus comprising:
an event identification circuitry configured to detect an occurrence of a user authentication event associated with a user;
communications hardware configured to receive a signature from the user captured during the user authentication event;
the event identification circuitry further configured to determine whether the user authentication event corresponds to an authentic event type; and
in an instance in which the user authentication event corresponds to an authentic event type:
the event identification circuitry is further configured to determine a signature parameter set for the signature; and
signature management circuitry is configured to store the signature and corresponding signature parameter set in a signature profile associated with the user within a signature corpus.

11. The apparatus of claim 10, wherein the communications hardware is further configured to:
receive a signature verification request, wherein the signature verification request comprises a candidate signature from the user; and
the signature management circuitry is further configured to:
determine, using a signature authentication model, a signature verification result for the candidate signature based on the candidate signature and the signature profile, wherein the signature verification result is indicative of whether the candidate signature is verified or non-verified; and
provide a signature verification response comprising the signature verification result.

12. The apparatus of claim 11, wherein the signature management circuitry is further configured to:
generate, using the signature authentication model, a signature subset comprising one or more signatures from the signature profile;
generate, using the signature authentication model, an aggregated signature verification likelihood score for the candidate signature based on the signature subset; and
determine whether the aggregated signature verification likelihood score for the candidate signature satisfies an aggregated signature verification likelihood score threshold, wherein (a) the signature verification result is indicative that the candidate signature is verified in an instance in which the aggregated signature verification likelihood score for the candidate signature satisfies the aggregated signature verification likelihood score threshold and (b) the signature verification result is indicative that the candidate signature is non-verified in an instance in which the aggregated signature verification likelihood score for the candidate signature fails to satisfy the aggregated signature verification likelihood score threshold.

13. The apparatus of claim 12, wherein the signature management circuitry is further configured to:
generate a signature similarity score for each signature stored in the signature profile, wherein the signature similarity score for a signature is based on an inferred similarity between a corresponding signature parameter set for the signature and a signature parameter set for the candidate signature; and
select one or more signatures for the signature subset based on an associated signature similarity score.

14. The apparatus of claim 10, wherein the signature corpus is a blockchain network and the signature profile is stored on the blockchain network.

15. A computer program product for providing continuous signature management, the computer program product comprising a non-transitory computer-readable storage medium storing instructions that, when executed by an apparatus, cause the apparatus to:
detect an occurrence of a user authentication event associated with a user;
receive a signature from the user captured during the user authentication event;
determine whether the user authentication event corresponds to an authentic event type; and
in an instance which the user authentication event corresponds to an authentic event type:
determine a signature parameter set for the signature, and
store the signature and corresponding signature parameter set in a signature profile associated with the user within a signature corpus.

16. The computer program product of claim 15, wherein the instructions, when executed by the apparatus, further cause the apparatus to:
receive a signature verification request, wherein the signature verification request comprises a candidate signature from the user;
determine, using a signature authentication model, a signature verification result for the candidate signature based on the candidate signature and the signature profile, wherein the signature verification result is indicative of whether the candidate signature is verified or non-verified; and
provide a signature verification response comprising the signature verification result.

17. The computer program product of claim 16, wherein the instructions, when executed by the apparatus, further cause the apparatus to:
generate, using the signature authentication model, a signature subset comprising one or more signatures from the signature profile;
generate, using the signature authentication model, an aggregated signature verification likelihood score for the candidate signature based on the signature subset; and
determine whether the aggregated signature verification likelihood score for the candidate signature satisfies an aggregated signature verification likelihood score threshold, wherein (a) the signature verification result is indicative that the candidate signature is verified in an instance in which the aggregated signature verification likelihood score for the candidate signature satisfies the aggregated signature verification likelihood score threshold and (b) the signature verification result is indicative that the candidate signature is non-verified in an instance in which the aggregated signature verification likelihood score for the candidate signature fails to satisfy the aggregated signature verification likelihood score threshold.

18. The computer program product of claim 17, wherein the instructions, when executed by the apparatus, further cause the apparatus to:
generate a signature similarity score for each signature stored in the signature profile, wherein the signature similarity score for a signature is based on an inferred similarity between a corresponding signature parameter set for the signature and a signature parameter set for the candidate signature; and
select one or more signatures for the signature subset based on an associated signature similarity score.

19. The computer program product of claim 15, wherein the signature corpus is a blockchain network and the signature profile is stored on the blockchain network.

20. The computer program product of claim 19, wherein the instructions, when executed by the apparatus, further cause the apparatus to:
in response to determining the user authentication event corresponds to the authentic event type, generate a new block on the blockchain network, wherein the new block comprises the signature received during the user authentication event.
